(19) United States
(12) Patent Application Publication
(10) Pub. No.: US 2004/0193917 A1
(43) Pub. Date: Sep. 30, 2004

(54) Application programming interface to securely manage different execution environments

(76) Inventor: Paul C. Drews, Gaston, OR (US)

Correspondence Address: Timothy N. Trop, TROP, PRUNER & HU, P.C., 8554 KATY FWY, STE 100, HOUSTON, TX, 77024-1841, US

(21) Appl. No.: 10/397,701

(22) Filed: Mar. 26, 2003

(51) Int. Cl. H04L 9/00

(52) U.S. Cl. 713/201

(57) ABSTRACT

An application programming interface is provided on a user platform for securely managing different execution environments of a device. The application programming interface, in one embodiment, may present policies used by agents that selectively authorize installation and execution for different executable elements at the user platform based on a general-purpose library. The general-purpose library may provide a multiplicity of interfaces in order to securely control the execution environment in the device, such as a wireless device. In this manner, models authorizing installation and execution on a user platform may not be built from scratch at a device.

### BACKGROUND

Embodiments of this invention relate generally to an application programming interface.

Computing and communication devices often operate in a communication environment in which installation and configuration of executable elements including software and commands may occur through the communication medium. In such an environment, there are often a variety of different parties that should have different controls over different aspects of execution in the target platform. As an example, when provisioning a cell phone, such parties include the manufacturer, the service provider (carrier), and several different developers of end-user software applications for the cell phone. In this example, it may be appropriate for the manufacturer to install new low-level system software such as device drivers, firmware upgrades, etc. It may be appropriate for the carrier to install or upgrade software that controls a cell-phone's cellular radio or implements cellular communication protocols according to the standards and legal requirements for radio transmissions and communication protocol standards. Similarly, it may be appropriate to allow end-user software developers to install or upgrade software within some allocated installation area under some resource limit.

In addition to initial installation and configuration, when software supplied by these different parties runs, it should have permissions to do different things depending on the software supplier. In the example given above, an end-user application should be permitted to place a call after end-user confirmation, but should not be permitted to change the transmission power level of the cellular radio. Carrier-supplied software for controlling the cellular radio should be allowed to control the radio but should not be permitted to place calls. These observations apply not only to conventional units of installed software, but also other units of execution such as commands. As with a unit of installed software, a command may be associated with a party that supplies the command, and any decision on whether or not to perform the command should include a consideration of the permissions allowed to the supplying party.

Industry standards, models for managing computing and communicating devices evolve rapidly along with customer expectations. Categories of software change as technology advances, for example, the future technology environment in which cell phones operate may involve more, fewer, or different parties than the Manufacturer, Carrier, and Software Developer categories given in the example above. The set of possible actions or commands that can be performed may evolve most rapidly of all, since the software that is installed often defines the commands.

There is a best-known practice in the industry wherein software suppliers digitally sign software using a private key and software recipients verify the digital signature using a configured public key that determines the source from which software shall be deemed acceptable. However, this basic practice only forms a foundation of an overall authorization model that governs the operation of a particular system. The overall authorization model defines such things as the set of possible operations in the system, the parties that the system recognizes, and the policies that determine the permissions of parties to perform operations, and provides a facility to checking and enforcing such policies and permissions. Since the set of operations, the set of parties, and the execution environments themselves evolve so rapidly, there is a continuing need for a flexible, extensible system that allows system designers to rapidly build and evolve authorization models.

### BRIEF DESCRIPTION OF THE DRAWINGS

FIG. 1 is a schematic depiction of a device consistent with one embodiment of the present invention;

FIG. 2 is a chart showing interoperability between many different participating entities that may change over time for the user platform shown in FIG. 1 according to one embodiment of the present invention;

FIG. 3 is a schematic depiction of configuring authorization for the user platform shown in FIG. 1 in accordance with one embodiment of the present invention;

FIG. 4A is a flow chart showing enabling of authorization rights for executable elements on the user platform using the application programming interface shown in FIG. 1 according to one embodiment of the present invention;

FIG. 4B is a flow chart showing verification of authorization rights of the executable elements using the implemented authorization model on the user platform shown in FIG. 1 according to one embodiment of the present invention;

FIG. 4C is a flow chart showing load time role association and run time permission check of executable elements using the application programming interface on the user platform shown in FIG. 1 according to one embodiment of the present invention;

FIG. 5 is a graph showing a certificate chain tracing for the application programming interface shown in FIG. 1 according to one embodiment of the present invention;

FIG. 6 is a schematic depiction of the application programming interface shown in FIG. 1 for updating authorization of executable elements on the user platform in accordance with one embodiment of the present invention;

FIG. 7 is a flow chart showing use of the application programming interface shown in FIG. 1 at the user platform to selectively enabling the execution of the executable elements based on the authorization rights according to one embodiment of the present invention;

FIG. 8A is a schematic depiction of a communication link to update authorization of executable elements on a mobile user platform using the application programming interface shown in FIG. 1 in accordance with one embodiment of the present invention;

FIG. 8B is a schematic depiction of a wireless communication link to update authorization of executable elements on a wireless user platform using the application programming interface shown in FIG. 1 in accordance with one embodiment of the present invention;

FIG. 9A is a processor-based system based on the mobile user platform shown in FIG. 8A incorporating the execution environment manager in accordance with one embodiment of the present invention; and

FIG. 9B shows a wireless manageable user platform based on the wireless mobile platform shown in FIG. 8B incorporating the execution environment manager in accordance with one embodiment of the present invention.

### DETAILED DESCRIPTION

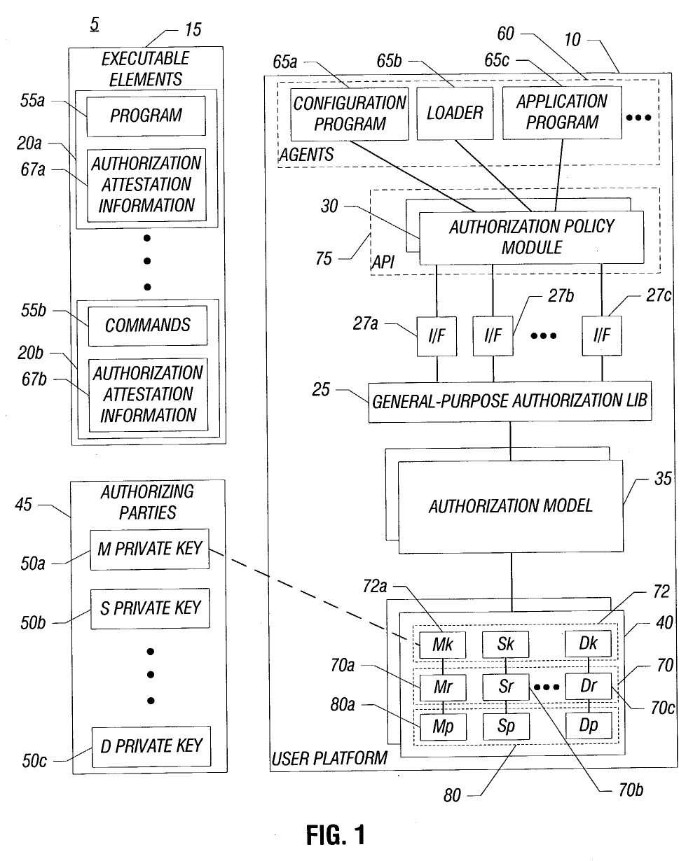

A device 5 (e.g., a processor-based mobile device) shown in FIG. 1 may be based on a user platform 10 on which installation and execution of different executable elements 15, including program elements 20a and command elements 20b, may be remotely and securely performed, according to one embodiment of the present invention. Examples of the device 5 include mobile phones, personal digital assistants (PDAs), and computers including a laptop or a desktop computer. Permission to install and execute program elements 20a and command elements 20b may vary according to different policies, and the permission to perform detailed actions attempted by program elements 20a and command elements 20b may vary according to different policies. Policies vary from one user platform 10 to another, and policies vary over time as well. Accordingly, the user platform 10 may supply a general-purpose authorization library 25 that provides a multiplicity of interfaces 27a, 27b, 27c that allow a multiplicity of authorization policy modules 30 to implement, configure, and enforce a multiplicity of authorization models 35. In one embodiment, the multiplicity of authorization policy modules 30 may provide an application programming interface (API) 75 to securely manage the execution environment of the device 5.

In general, each authorization model 35 may involve the management of authorization information 40. In particular, authorization information 40 may include the definition of a set of roles 70 such as a manufacturer role (Mr) 70a, a service provider role (Sr) 70b, and a developer role (Dr) 70c. Those skilled in the art will recognize that these roles 70 are presented as common examples although the present invention is not limited to such examples. In fact, the set of roles 70 in a particular authorization model 35 may be static or dynamic, according to the policy implemented by its authorization policy module 30.

Along with the set of roles 70, an authorization model 35 may involve defining a set of permissions 80 associated with a corresponding role in the defined set of roles 70. Furthermore, the authorization model 35 may involve configuring a set of one or more public keys 72 associated with a corresponding set of roles 70. However, a set of public keys 72 may be associated with the set of roles 70 in a variety of ways. One embodiment that may be preferred over others may store a digital certificate containing a public key 72a in a hierarchically named storage space under the name of the corresponding role 70a. The hierarchical nature of the name space along with judicious choice of names prevents “collisions” between the public keys 72a in different authorization models 35 in accordance with one embodiment. Embedding the public key 72a in a digital certificate is a well-known way of keeping useful meta-information about the public key 72a such as a key length and a digital signature algorithm that can be used with public key 72a.

There may be a variety of different agents 60 in the user platform 10 that use the services of an authorization policy module 30 built according to the present invention. Examples of these agents 60 include, but are not limited to, a configuration program 65a, a loader 65b, and an application program 65c. Those skilled in the art will recognize that some of these agents 60 (such as the application program 65c) may operate entirely within the user platform 10, while other agents (such as the configuration program 65a) may operate as a proxy for an agent outside the user platform 10. In this way, one embodiment of the present invention supports both the authorization models 35 that govern the behavior of internal programs, i.e., the agents 60 and also the authorization models 35 that govern the behavior of remote management of the user platform 10.

In operation, according to one embodiment, the authorization information 40 may be provided to the user platform 10 prior to the provisioning of the device 5. While provisioning, configuring, or managing the device 5, a variety of different authorizing parties 45 may supply the executable elements 15 for installation or execution on the user platform 10. Each authorizing party 45 has a private key corresponding to a public key 72a associated with the authorizing party's 45 role 70a. For example, a manufacturer would hold a manufacturer private key 50a corresponding to a configured manufacturer public key 72a stored in any user device, such as the device 5 for which the manufacturer should be authorized to supply executable elements.

An authorizing party 45 that supplies an executable element 15 attests that the executable element is authorized by supplying authorization attestation information 67a, 67b. This authorization attestation information 67a, 67b may be supplied to the user platform 10 along with a program 55a or a command 55b that is authorized. For example, a manufacturer supplying an executable element 15, such as the program 55a, may create a digital signature of the program 55a. The manufacturer produces the digital signature using the private key 50a held by the manufacturer that corresponds to the public key 72a associated with the manufacturer role 70a configured in a target user platform such as the user platform 10. The digital signature forms the authorization attestation information 67a for the program 55a. The full authorized program element 20a including both the original program 55a and authorization attestation information 67a may be supplied to the user platform 10.

When an executable element 15, e.g., the full authorized program element 20a is supplied to the user platform 10, a variety of different agents, i.e., among the agents 60 may use the authorization attestation information 65a at different times according to the policies in effect for the device 5. As an example, the configuration program 65a may have the policy that only the program 55a from the authorized manufacturer may be installed. Accordingly, the configuration program 65a calls an appropriate authorization policy module 30 to test for adherence to this policy, supplying the program 55a and authorization attestation information 67a that is to be tested. The authorization policy module 30 calls the interfaces 27a, 27b, and 27c of the general-purpose authorization library 25 to determine whether the digital signature in the authorization attestation information 67a created with the manufacturer's private key 50a verifies properly and corresponds to one of the manufacturer public keys 72a stored for the manufacturer role 70a in the user platform 10. If all the tests pass, the authorization policy module 30 returns with success and the configuration program 65a may proceed with installation of the program 55a.

In a further example, once the program 55a is installed, the loader 65b may attempt to load the program 55a and let it run as the application program 65c. Those skilled in the art will recognize that the policies and tests for loading the program 55a are very similar to those described for installation of the program 55a. However, as the application program 65c executes, it may attempt to perform detailed actions that may or may not be permitted according to detailed permissions defined by the associated authorization policy module 30. When such an action is attempted, the authorization policy module 30 may determine which of the set of roles 70 (for example, manufacturer role 70a) is associated with the program 55a. The authorization policy module 30 may use the interfaces 27a, 27b, and 27c supplied by the general-purpose authorization library 25 to retrieve and examine the permissions from the set of permissions 80 (for example, the manufacturer permissions (Mp) 80a) associated with the program's 55a role 70a, and allow or not allow the action depending on whether the permissions include the attempted action. To keep such run-time permission tests efficient, the loader 65b of the user platform 10 may determine the role or permissions of the application program 65c at the time the program 55a is loaded, and associate the role 70a or the permissions 80a with the application program 65c in a secure way.

Those skilled in the art will recognize that the authorization information 40 for an authorization model 35, such as one of its public keys 72a, may be reconfigured from time to time. To keep the system secure, reconfiguration itself may depend upon an authorization policy. Accordingly, one embodiment of the present invention may include an associated authorization policy module 30 that implements and enforces the policies for replacing configured public keys such as the public key 72a. Briefly, this authorization policy may require that only the currently authorized party for a particular role 70 such as the role 70a may authorize the corresponding configured public key such as the public key 72a to be changed.

In operation, an agent of the set of agents 60 performing such a reconfiguration may call the authorization policy module 30 to retrieve a unique number for the transaction (i.e., a “nonce”). The agent may then construct a command, such as the command 55b that may include at least the request to change a configured public key, indicating which key is to be changed, the new key value, and the unique transaction number. The agent digitally signs the command 55b using the old (current) private key, thus producing the full authorized program element 20b including the command 55b and the authorization attestation information 67b in some embodiments. This information may be passed to the associated authorization policy module 30 as a request to change permissions.

In turn, the associated authorization policy module 30 confirms that the digital signature verifies using the proper public key, that the command is well-formed, and that a correct transaction number was provided. If all tests pass, the new public key is configured, and the transaction number is updated to guard against replay of the same command at a different time.

In one embodiment, the transaction number should be unique to the user platform 10, to guard against replay of that command to a different user platform. Well-known techniques in the industry may be used to generate unique transaction numbers with these properties. In some cases, the authorizing parties 45 of an authorization model 35 may be parties outside the user platform 10. In these cases, the user platform 10 may be managed in a remote-management scenario. In a remote-management scenario, the actual agent acting on the user platform 10 may be the configuration program 65 a that communicates with a remote management software, acting as the remote management software's local proxy. Techniques for doing such remote communication (such as a remote procedure call) are well-known in the industry and do not need to be described here.

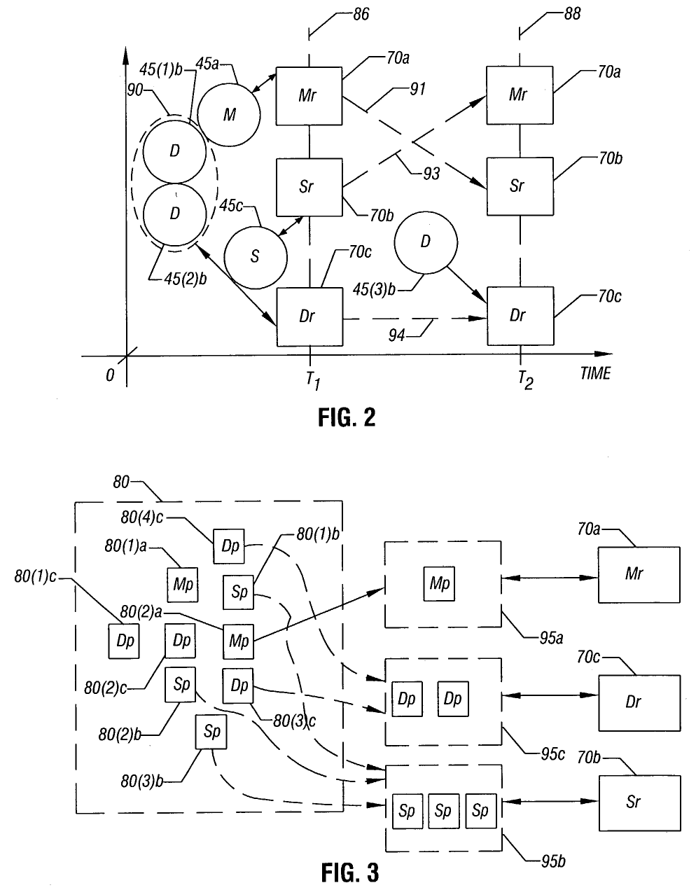

Referring to FIG. 2, a chart shows interoperability between many different participating entities that may change over time for the user platform 10, in accordance with some embodiments of the present invention. Specifically, the chart shows different kinds of the authorizing parties 45, that may be desirably expressed on the user platform 10 supplying the executable elements 15 including software, commands, or other units of execution to the device 5 shown in FIG. 1 where they may be executed. To this end, the chart shown in FIG. 2 illustrates a flexible way so that a set of authorizing parties may be either statically defined or dynamically extended as the execution environment of the device 5 evolves, such as over a period of time according to one embodiment. However, an individual or an organization may act as one kind of party at one time and another kind of party at another time. Furthermore, several different individuals or organizations may act as the same kind of party.

In particular, while a first configuration of role-based kind of authorizing parties is indicated at time (T1) 86, a reconfiguration thereof is shown at time (T2) 82. The term “role” is used in this example to refer to a “kind of party,” in contrast to the actual identity of an individual or an organization that may act in that role, consistent with one embodiment.

In operation, prior to the time (T1) 86, a set of different kinds of authorizing parties may be statically defined. Thereafter, this statically defined set of different kinds of authorizing parties may be dynamically extended subsequent to the time (T1) 86, as indicated. For example, a batch of developers (D) 90, including at least two developers 45(1)b and 45(2)b may be statically defined as the same kind of authorization party having a role-based configuration as the developer role (Dr) 70c. Likewise, a service provider (S) 45c may have the service provider role (Sr) 70b associated therewith. The manufacturer role (Mr) 70a may be associated with a manufacturer (M) 45a, in this example at the time (T1) 86 for the execution environment at the user platform 10.

As indicated by an arrow 91, the manufacturer role (Mr) 70a may be reconfigured to indicate as the service provider role (Sr) 70b at the time (T2) 88 for the manufacturer 45a, in one embodiment. In a similar fashion, the service provider role (Sr) 70b may be reconfigured as indicated by an arrow 93 to indicate the manufacturer role (Mr) 70a. Moreover, the developer role (Dr) 70c may be extended as indicated by an arrow 94 to include a developer (D) 45(3)b, indicating a dynamic extension of the batch of developers (D) 90. This may extend the execution environment of the device 5, which may have evolved since the time (TI) 86.

Besides configuring or updating the source of authorization, i.e., the kind of authorization party for a role, the user platform 10 may provide for extensibility of the roles 70, the permissions 80, and associations therebetween. Additionally, extensibility of the capability to specify units of execution that can act in a role may further be provided, in some embodiments of the present invention. Using this capability, the permissions 80 may be either statically defined or dynamically extended. In either case, the permissions 80 may be configured to allow or not allow a particular action.

Referring to FIG. 3, by grouping the permissions 80, a multiplicity of sets of permissions 95a, 95b, 95c may be obtained in one embodiment of the present invention. The sets of permissions 95a, 95b, 95c may be associated with the appropriate roles, e.g., the manufacturer role (Mr) 70a, the service provider role (Sr) 70b, the developer role (Dr) 70c, respectively.

More particularly, while a first manufacturer permission (Mp) 80(2)a may form the set of permissions 95a, a second manufacturer permission (Mp) 80(1)a may be used to dynamically extend this set. Likewise, in the illustrated example, three of the service provider permissions (Sp) 80(1)b through 80(3)b may be used to form the set of permissions 95b. Although developer permissions (Dp) 80(1)c to 80(4)c may be statically defined, only two of the four permissions (Dp), i.e., 80(3)c and 80(4)c may form the set of permissions 95c. The remaining two of the developer permissions (Dp), i.e., 80(1)c and 80(2)c are shown to be statically defined, but later these may be dynamically added to the permissions 80, in turn, reconfiguring the set of permissions 95c based on evolution of the execution environment of the device 5 shown in FIG. 1.

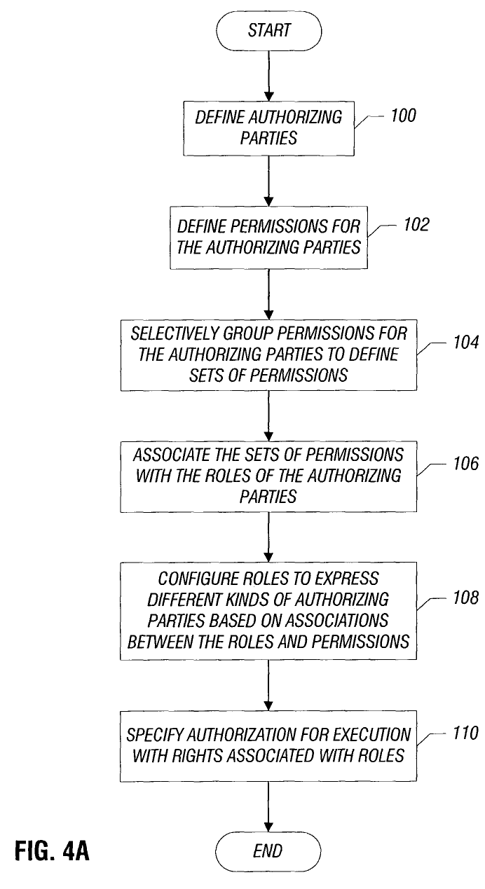

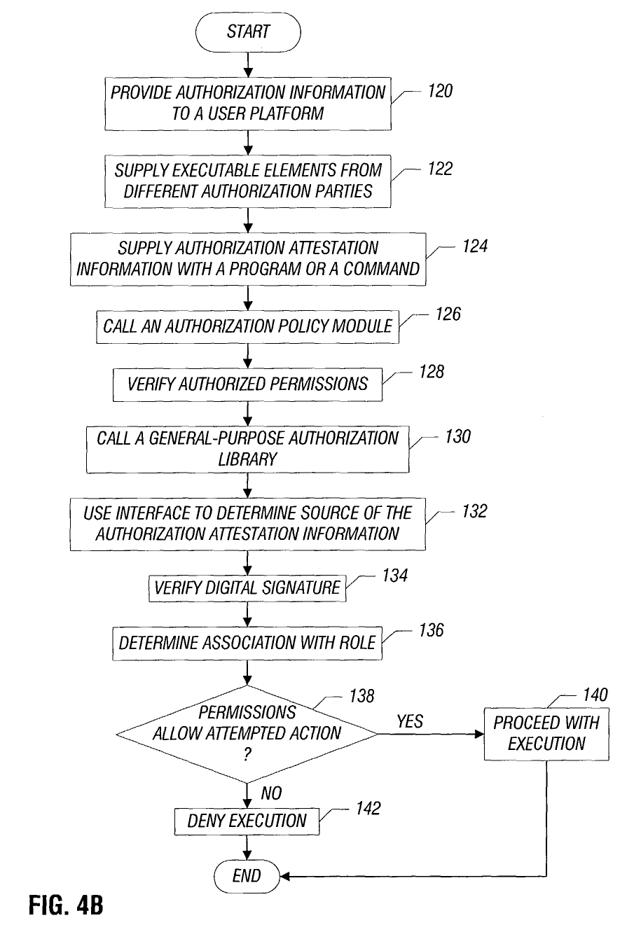

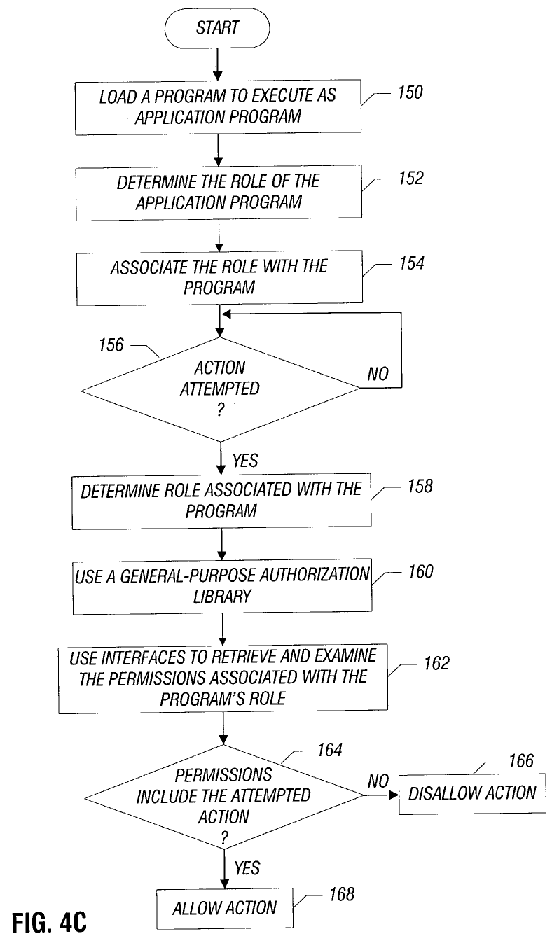

Referring to FIG. 4A, a flow chart shows a flexible way to configure authorization according to some embodiments of the present invention. At block 100, the authorizing parties 45 may be defined using the application programming interface 75 shown in FIG. 1. Consistent with one embodiment, the application programming interface 75 may include, but is not limited to, procedure calls with defined syntax and semantics, protocols with defined syntax and semantics, commands, procedure calls with defined syntax and semantics, protocols with defined syntax and semantics that provide signal communication over one or more busses that may be used on the device 5, enabling the user platform 10 to operate the device 5. As described above, at block 102, the permissions 80 for the authorizing parties 45 may be defined. At block 104, the permissions 80, such as shown in FIG. 3, may be selectively grouped for the authorizing parties 45, defining one or more sets of permissions, for example the sets 95a through 95c. Thereafter, the sets of permissions 95a through 95c may be associated with the roles 70 of the authorizing parties 45 at block 106.

As shown in FIG. 2, based on the associations between the roles 70 and the permissions 80, the roles 70 may be configured to express different kinds of the authorizing parties, at block 108. Authorization for execution with rights associated with roles 70 may be specified at block 110, as one example. This authorization may govern the installation and execution of units of execution, such as the executable elements 15, in one embodiment of the present invention.

Although not so limited, the source of authorization, i.e., the authorizing parties 45 for a particular role may be configured or updated in a cryptographically secure manner on the user platform 10. In particular, the user platform 10 may securely attest and verify that a unit of execution is associated with a particular role, i.e., it was supplied by the role's source of authorization in a cryptographically secure manner. In this way, on the user platform 10, the integrity of the unit of execution, such as that of the executable elements 15, may be verified. In one embodiment, the ability to attest to the authority and integrity of the unit of execution may be delegated to a multiplicity of levels.

Turning now to FIG. 4B, a flow chart shows verification of the authorized permissions, according to one embodiment of the present invention. The authorization information 40 may be provided to the user platform 10 at block 120 in many embodiments of the present invention. Different authorization parties, i.e., the authorizing parties 45 may supply the executable elements 15 at block 122 to the user platform 10. At block 124, the authorization attestation information 67a associated with the program 55a or the authorization attestation information 67b associated with the command 55b may further be supplied to the user platform 10 of the device 5.

A call at block 126 to the authorization policy module 30 shown in FIG. 1, may verify the authorized permissions 80 at block 128, in some embodiments. Another call to the general-purpose authorization library 25 at block 130 by the authorization policy module 30 may determine the source of the authorization attestation information 67a or 67b at block 132, using the interfaces 27a through 27d. As a result, at block 134, the digital signature obtained from the authorization attestation information 67a may be verified, as one example. At block 136, association with the roles 70 may be determined for the permissions 80.

A check at diamond 138 may ascertain whether the permissions 80 allow an attempted action at the user platform 10 by the program 55a in one scenario. If the permissions 80 do indicate at the diamond 138 that the attempted action is allowed, the program 55a may proceed with execution at block 140. Otherwise, execution of the program 20a may be denied at block 142 at the user platform 10.

As shown in FIG. 4C, when the program 55a is indicated to be appropriately authorized to execute on the platform 10, at block 150, the program 55a may be loaded by the loader 65d as the application program 65c. At block 152, the role of the application program 65c may be determined based on the configured authorization. For example, the Manufacturer role 70a may be associated with the program 55a when the source of the authorization is a Manufacturer at block 154.

When the executing application program 65c attempts an action, a check at diamond 156 may detect such occurrence. Upon detecting the attempted action, at block 158, association of the role 70a with the application program 65c may be determined. The general-purpose authorization library 25 may be used at block 160 for this purpose by the authorization policy module 30. Using the interfaces 27a through 27c, the authorization policy module 30 of the application programming interface 75 may retrieve and examine the permissions 80 associated with the application program's 65c role 70 at block 162.

A check as to whether the permissions 80 include the attempted action may decide whether or not to allow the action to proceed at a diamond 164. If the permissions 80 do not allow the attempted action at the diamond 164, the action may be disallowed at block 166. Conversely, when the permissions 80 indicate that the attempted action is appropriate, at block 168, the action may be allowed to continue for the program 20a.

In other embodiments, the program 55a may be executed at the device 5 when appropriately authorized to do so on a manageable user platform of a mobile device. As one example, for the mobile device the existing authorization permissions to execute the program 55a may be redefined from its current specification, supporting a variety of applications and services developed by other vendors in several development environments for disparate user platforms. Examples of the applications and services include Internet capabilities and/or wireless data services.

By flexibly enabling deployment of the program 55a and other types of provisionable content onto the device 5, desirable services and applications may be offered to a user, utilizing the device 5 more effectively in many situations. In other words, the application programming interface 75 may provide one common deployment framework for selectively authorizing execution of certain software, such as an application or code, satisfying user preferences and features in accordance with some embodiments of the present invention. In this way, a number of resources and features intended to be provisioned in the device 5 may be made flexibly available to the users across disparate user platforms on different device types.

To this end, a conventional communication interface may establish communications with an updating platform (e.g., the user platform 10) over a communication link or vice versa. Examples of the communication interface include a network interface card, a modem card or an external modem, a wireless communication interface, or any other communication interface capable of providing wireless or wired communications in order to manage the execution environment. Examples of the communications include those over a network link, such as via a local area network (LAN), or on an airwave communication link, such as an infrared, radio or a cellular phone link.

The application programming interface 75 may incorporate generalized features in some embodiments of the present invention. Examples of the generalized features include one or more data buffers and access control lists. The data buffers and access control lists may enable building of at least one authorization model different than a previous authorization model for a selected batch of authorized permissions from the original set of authorization permissions 80.

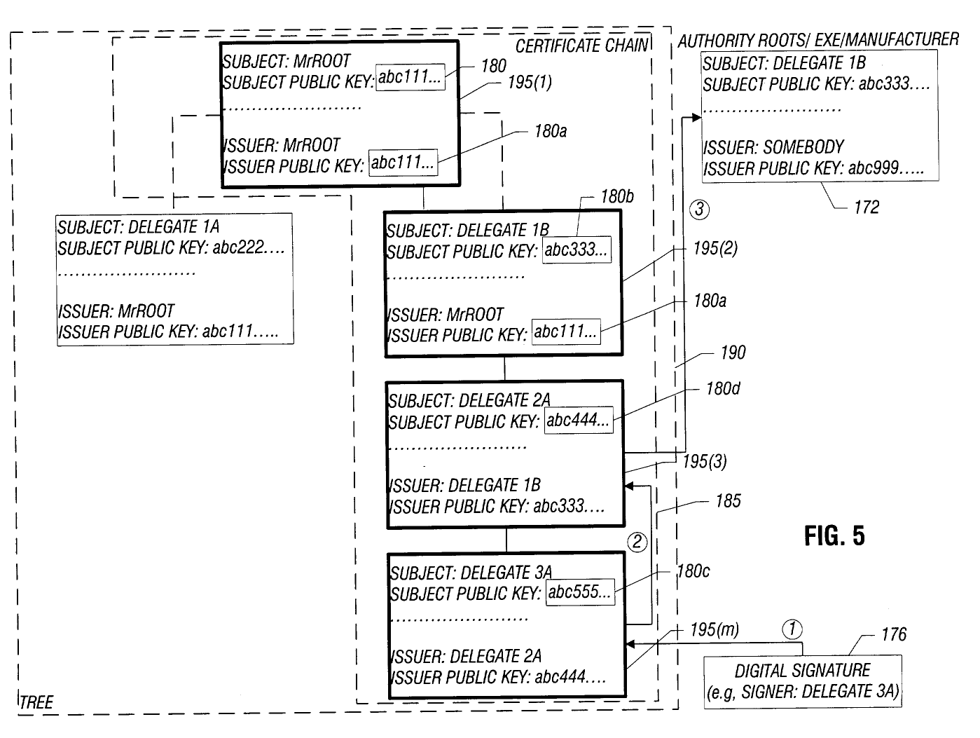

A common desire in evolving different authorization models is the desire to delegate authority from a top-level organization or agent to sub-organizations or subordinate agents. Accordingly, the present invention in one embodiment may use a variation of certificate-chain tracing as shown in FIG. 5. FIG. 5 shows a chain of digital certificates 195(1 . . . m) as is well-known in the art, where the “root” digital certificate 195(1) is the issuer of the next digital certificate 195(2), which is in turn the issuer of digital certificate 195(3) and so forth, up to some final digital certificate 195(m). In general, each digital certificate such as 195(2) is a signed message signed by an issuer attesting to the identity of a subject. In the example of the digital certificate 195(2) the issuer signature may be verified using the issuer's public key 180a, thereby confirming the identity of the holder of private key corresponding to the subject public key 180b. The subject public key 180b of a digital certificate 195(2) is the issuer public key of the next digital certificate 195(3) in the chain.

The root digital certificate 195(1) is a special case in that it is self-signed. Its subject public key 180 and issuer public key 180a are the same as one another. Since a holder of a digital certificate can issue multiple digital certificates, the set of digital certificates delegated from a root certificate 195(1) forms a tree 190. For the purpose of this example, only a single chain 185 is considered although the present invention is not so limited. The chain consists of a sequence of individual steps where at each step there is a component to be verified such as a digital certificate 195(3) and a public key 180b with which to perform the verification. A certificate chain can be verified between widely separated steps by performing all the verifications at all the intervening steps in the sequence.

The concepts of certificate chains just described are well-known in the art. In one embodiment of the present invention, certificate chains may be used in a particular way to perform delegation. Authorization information 67a for a program 55a may be comprised of a digital signature 176 of the program 55a and may be further comprised of a certificate chain 185. The authorizing information 40 in a platform 10 may include an authorizing public key 72a stored under a particular name 172 such as “authority roots/exe/manufacturer” in a namespace of authorizing information maintained by an authorization model 35. When the general-purpose authorization library 25 verifies the authorization attestation information 67a, it may include some verification steps from the certificate chain as shown by the numbered arrow 2, a verification of the executable element or program 55a as shown by the numbered arrow 1, and a verification of a digital certificate in the certificate chain using a public key from stored authorization information 172 as shown by the numbered arrow 3. Those skilled in the art will recognize that many different algorithms or sequences may be used to do these verification steps, as long as an unbroken sequence of verification steps can be traced from the program 55a to the public key of one of the configured elements of authorization information 172.

Those skilled in the art will recognize that the part of a digital certificate chain involved in a verification sequence may be longer or shorter, and may omit certificates at either end of the chain. In one embodiment, the chain may be eliminated entirely without any basic change to the algorithms or verification rules. In this way, the present invention may use digital certificates issued through a Public Key Infrastructure. However, it is not limited to use of a Public Key Infrastructure. In simpler embodiments participants may use keys, digital certificates, or certificate chains created independent of a Public Key Infrastructure.

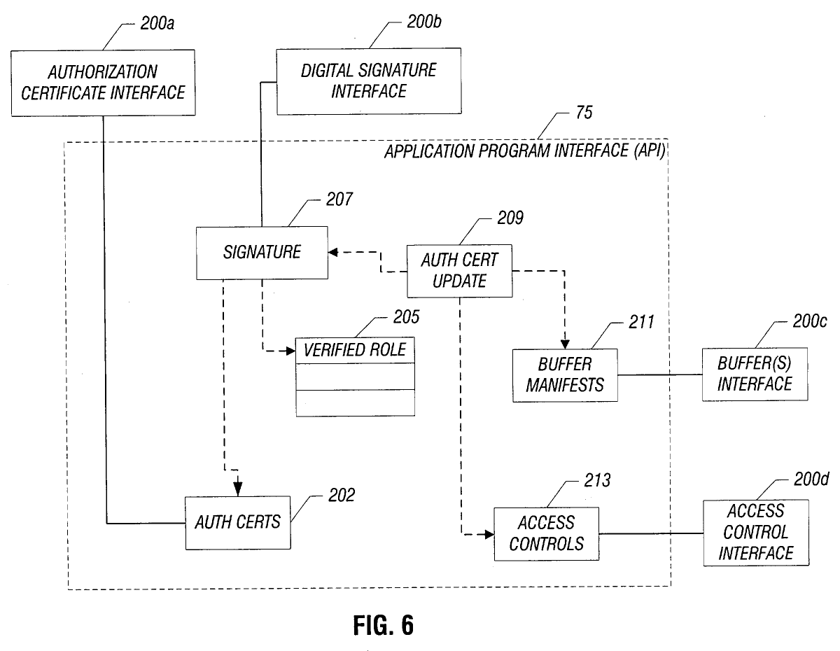

A successful verification and trace through a digital certificate chain has two results. First, it confirms that the executable element or program 55a is unmodified since its signature. Second, since it traces back to a particular element 172 of authorization information stored in a namespace of roles, it identifies the authorized role of the agent that produced the signature. In the descriptions that follow, variations of the phrase “. . . the digital signature 176 may be traced to . . . ” are used to refer to any process that obeys these verification rules. Referring to FIG. 6, the application programming interface 75 is shown in accordance with some embodiments of the present invention for configuring and/or updating the authorized permissions of the executable elements 15 on the user platform 10. Consistent with one embodiment, for the application programming interface 75 a multiplicity of interfaces, such as the interface 27a, may provide an authorization certificate interface 200a, a digital signature interface 200b, a buffer(s) interface 200c, and an access control interface 200d.

According to one embodiment, these interfaces 200a through 200d may manipulate several types of objects whose presence is therefore evident through the interfaces. These objects may include: a) a set of authorization certificates 202 stored persistently in a name-space wherein the name under which an authorization certificate is stored corresponds to its role; b) a digital signature 207 that may be verified and traced to an authorization certificate and its corresponding role; c) a verified role 205 that may cache the results of verification of the digital signature 207 for later reference or rapid re-verification; d) buffer manifests 211 that may provide a way of describing an executable element (or other data element) as an ordered collection of contiguous data extents; e) access controls 213 that may provide an extensible way of describing permissions that may be associated with roles; and f) a built-in authorization certificate update module 209 that may serve as the authorization policy module 30 to govern the initialization and re-configuration of the repository of stored authorization certificates 202.

According to one embodiment the Authorization Certificate interface 200a may provide operations to search the repository of Authorization Certificates 202, add, remove, and replace Authorization Certificates, and optionally create a digital signature using one of the digital certificates. Operations that alter the configuration of Authorization Certificates 202 may use the services of and may be governed by the policy implemented by the Authorization Certificate Update module 209.

According to one embodiment, the digital signature interface 200b may provide operations to manipulate authorization attestation information such as 67a, which may be a digital signature. The operations may include ones to search the repository of authorization certificates 202 for an authorization certificate to which this digital signature can be traced, and ones to verify the digital signature over an executable element such as 55a using a configured authorization certificate 202. The executable element may be a complex object represented as a buffer manifest 211. A successful verification may return the verified role 205. The digital signature interface 200b may further provide operations to retrieve the role-name corresponding to a verified role or perform a re-verification equivalent to the one that produced the verified role 205.

According to one embodiment, the buffers interface 200c may provide operations to construct and use an ordered vector of (buffer, offset, length) triples wherein each (buffer, offset, length) triple describes a contiguous region of in-memory data. Many techniques and variations for doing this are well-known in the art. The present invention may use such techniques embodied in the buffers interface 200c to represent a wide variety of types of executable elements such as 55a, including but not limited to a single Application binary file, a suite of applets, or a single command.

According to one embodiment, the access control interface 200d manages collections of associations between Role names and Capability names. Operations provided may include ones to serialize a collection in and out from an external representation, build, iterate through, and modify collections, and test for the presence of a role name, a capability name, or a role-capability pair. Many techniques and variations for doing this are well-known in the art. The present invention may use such techniques embodied in the access control interface 200d to represent a wide and extensible variety of capabilities. In particular, the use of names (strings) both as roles and as capabilities allows for very flexible extensibility and interpretation by customized authorization policy modules 30 that implement new authorization models 35.

Note that in one embodiment of the present invention where the authorization certificate Interface 200a provides operations to alter the set of stored authorization certificates 202, the embodiment comprises some policy for such alteration, even if the policy is a simple “no restrictions” policy. Since a “no restrictions” policy may be inappropriate in many cases, a preferred embodiment of the operations to replace or remove a stored authorization certificate 202 may include a challenge-response sequence.

For example, one challenge-response sequence may involve retrieving a unique “challenge” value from the interface. A command requesting that a particular authorization certificate 202 be replaced or removed maybe constructed such that the command includes the challenge value. The command may be signed with the private key that can be traced to the old (current) authorization certificate 202. Thereafter, the command may be submitted to the interface. Using the current (old) authorization certificate, the signature may be verified in addition to verifying that the challenge value supplied is correct. If all verifications succeed, the modification may be performed. As a side effect of the modification, the “challenge” value that will be retrieved next may be altered, e.g., to guard against replay.

In one embodiment of the present invention, the authorization certificate interface 200a may include operations in support of such a sequence. As one example, the user platform 10 may be a mobile user platform capable of supporting a wide range of operating systems and interfaces for wireless and/or wired execution environments. In this example, a challenge-response protocol may involve interaction between the device 5 and a caller or a vendor including a manufacturer, a carrier, a software developer, or an agency responsible for downloading the executable elements at the user platform 10.

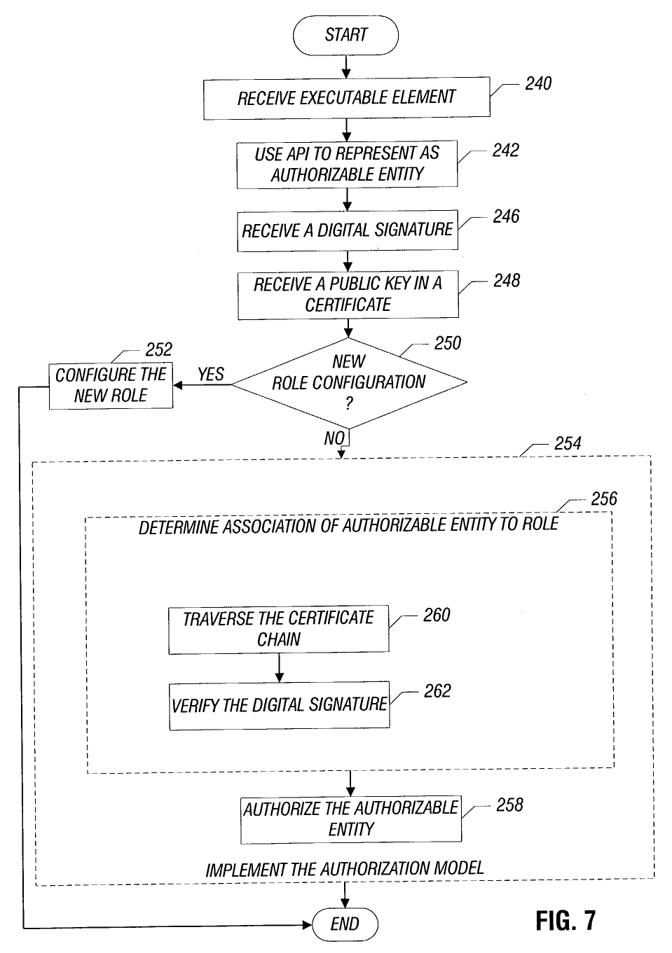

Referring to FIG. 7, when the user platform 10 receives the executable elements 15 at block 240, the application programming interface 75 may be used to represent the executable element 15 as an authorizable entity at block 242, in accordance with some embodiments of the present invention. As described above, the user platform 10 may receive an executable element 15 as a full authorized program element 20a. The full authorized program element 20a may include receiving authorization attestation information such as 67a, including receiving a digital signature in block 246 created with a private key corresponding to a public key in a digital certificate in block 248 that may in turn be part of a digital certificate chain. An executable element may be a request to create a new role configuration, or it may be an executable element for some part of the system outside the application programming interface 75. A check at diamond 250 may indicate whether a new role configuration is indicated. If so, the new role may be configured at block 252 in certain embodiments of the present invention.

However, when a new role configuration is not indicated at the diamond 250, the authorization model 35, as shown in FIG. 1, may be implemented at block 254. Implementing the authorization model 35 may involve determining association of the authorizable entity to a particular role at block 256. In addition, upon correct association, the authorizable entity may be appropriately authorized for execution or any other action that may be indicated at block 258. In some embodiments, determining the association of the authorizable entity to the particular role may involve traversing the certificate chain 185 shown in FIG. 5, at block 260. By tracing the certificate chain 185, the certificate may be verified using the digital signature at block 262 in one embodiment of the present invention.

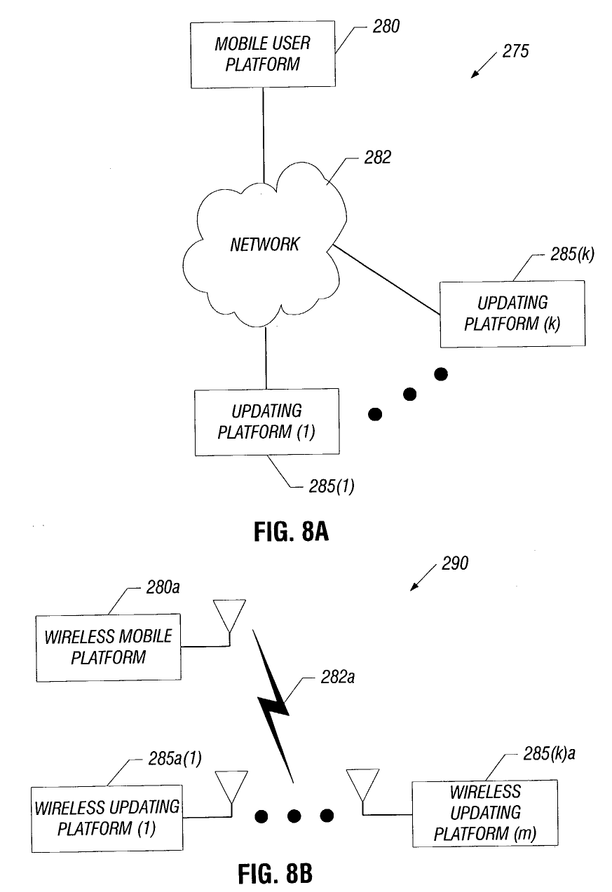

A communication link 275 is shown in FIG. 8A consistent with one embodiment of the present invention to update authorization of the executable elements 15 (FIG. 1) on a mobile user platform 280 using the application programming interface 75. Examples of the communication link 275 include one or more pathways for information to be routed. These pathways may be established through any type of medium such as electrical wire, fiber optics, cable, Plain Old Telephone System (POTS) lines, leased lines or even wireless communications. Also, information is considered “downloaded” when acquired from a remote location and provided to the platform through a link or a removable storage device such as a floppy disk, compact disk, smart card, and the like.

For certain embodiments of the present invention, a mobile user platform 280 may include hardware with additional functionality depending upon software executed therein. Examples of the mobile user platform 280 include, but are not limited or restricted to a computer (e.g., a laptop, desktop, hand-held, server, mainframe, etc.), imaging equipment (e.g., printer, facsimile machine, etc.), and a set-top box (cable box or network computer, etc.). Over a network 282, one or more updating platforms 285(1) through 285(k) may upgrade or programmably reconfigure the mobile user platform 280, as described above, without departing from the scope of the present invention.

The communication link 275 between the mobile user platform 280 and multiple updating platforms 285(1) to 285(k) may be established over the network 282. For example, the updating platform 285(1) may transmit a communication to the mobile user platform 280, requesting a configuration and/or an update of authorized permissions for execution of certain applications. The mobile user platform 280, using the communication link 275, having received a request with the appropriate information may communicate with the updating platform 285(1).

In accordance with another embodiment, a wireless communication link 290 is shown in FIG. 8B for updating a wireless user platform 280a by employing the application programming interface 75. Over an air interface 282a, one or more wireless updating platforms 285a(1) through 285a(m) may configure and/or update authorized permissions for execution of certain applications on the wireless user platform 280a in some cases. Examples of the updating platforms 285(1) and 285a(1) include mobile device vendors, service providers, content providers, manufacturers, carriers, and software suppliers. In other words, a variety of sources may provide such authorization rights information.

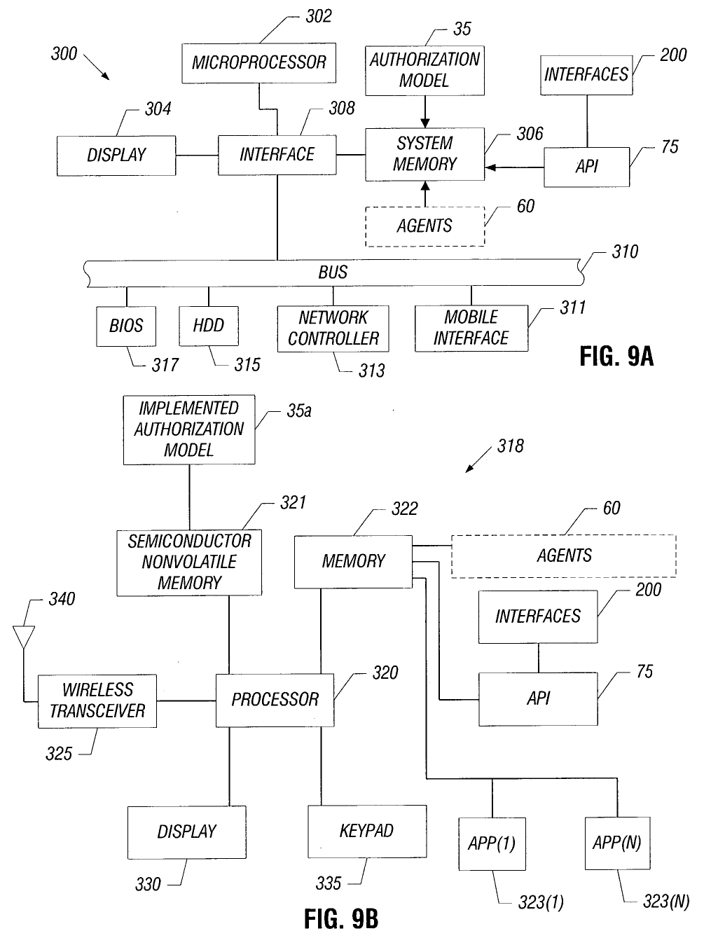

Some embodiments of the present invention may be implemented in software for execution by a processor-based system 300, as shown in FIG. 9A based on the mobile user platform 280 shown in FIG. 8A, incorporating the agents 60 to update (e.g., add or replace) authorization rights for execution, managing the execution environment on the mobile user platform 280. The processor-based system 300 may include a microprocessor 302 coupled to a display 304 and a system memory 306 through an interface 308. The system memory 306 may store the application programming interface 75 and the interfaces 200. Illustrative interface 308 may be a bridge circuit in an embodiment, or may include one or more buses in another embodiment. The agents 60 and the authorization models 35 may be loaded into the system memory 306 according to some operations consistent with certain embodiments of the present invention.

In the processor-based system 300, a primary bus 310 conforming to the peripheral component interface (PCI) standard, for example, may couple a mobile interface 311 for communications, a network controller 313, a hard disk drive (HDD) 315 and a basic input/output system (BIOS) 317 to the microprocessor 302 through the interface 308. In this manner, the primary bus 310 may couple to the interface 308 while providing an interface to other peripheral devices. For some embodiments of the present invention, the processor-based system 300 may be responsible for updating authorization rights for enabling execution of certain applications as set forth above on the mobile user platform 280 shown in FIG. 8A. Other wireless systems may be implemented in several different embodiments of the present invention.

Referring now to FIG. 9B, a wirelessly manageable user platform 318 is shown according to certain embodiments of the present invention to include a processor 320, which communicates with a semiconductor nonvolatile memory 321 and a memory 322. The memory 322 may store software including the execution environment agents 60. While the semiconductor nonvolatile memory 321 may store the implemented authorization model 35a, the memory 322 may store the agents 60, the application programming interface 75 with its interfaces 200 for selectively enabling the execution of applications (APP) 323(1) through 323(N) by provisioning appropriate authorization rights thereof.

The processor 320 may communicate with a wireless transceiver 325 and an antenna 340 (for example, a dipole antenna) associated therewith, for example, implementing a radio frequency (RF) based communication system, such as a cellular communication system. The processor 320 may further communicate with a display 330 and a keypad 335 in some embodiments of the present invention. The processor 320 may receive authorization rights information including the digital certificate chains 195 and/or digital signatures 176 for selectively authorizing execution for a selectable set of executable elements from another platform, such as the updating platform 285(1) or the wireless updating platform 285a(1). For example, in one embodiment of the present invention, the updating platform 285(1) may provide an indication of authorization for execution of a desired application, such as the application (APP) 323(1) to the processor 320, as described earlier. That indication of the authorization for execution, for example, may be received by the wireless transceiver 325 and the antenna 340, enabling the agents 60 to manage the execution environment on the wirelessly manageable user platform 318, according to various embodiments of the present invention.

Thus, in one embodiment an application programming interface is provided on a user platform for securely managing different execution environments of a device. The application programming interface may define at least two sets of executable elements to provide a set of authorization rights associated with at least two authorizing parties. To enable execution of a selectable set of executable elements of the two sets of executable elements, the application programming interface may selectively assign different authorization rights than the set of authorization rights to a different number of authorizing parties across the authorizing parties. In this manner, authorization models for execution may not be built from scratch at a device

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
selectively authorizing at least one of installation and execution for different executable elements at a user platform based on a general-purpose library that provides a multiplicity of interfaces in order to securely control the execution environment in a device.

2. The method of claim 1, comprising:
using the multiplicity of interfaces of the general-purpose library to define a multiplicity of authorization policy modules for said different executable elements.

3. The method of claim 2, comprising:
enabling one or more authorization models at the user platform based on at least one of the multiplicity of authorization policy modules.

4. The method of claim 2, comprising:
implementing an application programming interface in the device based on at least one of the multiplicity of authorization policy modules; and
accessing the general-purpose library using the application programming interface to implement, configure, or enforce said one or more authorization models.

5. The method of claim 2, comprising:
defining one or more authorizing parties for the device;
defining permissions for the authorizing parties; and
selectively grouping the permissions for the authorizing parties to configure a multiplicity of sets and permissions.

6. The method of claim 5, comprising:
associating the sets of permissions with the roles of the authorizing parties;
configuring the roles to express different kinds of authorizing parties based on the associations between the roles and permissions;
specifying authorization for execution of said different executable elements with the permissions associated with roles.

7. The method of claim 6, comprising:
receiving authorization information on the user platform;
receiving said different executable elements from said one or more authorizing parties, wherein said different executable elements including a program or a command; and
receiving authorization attestation information with the program or the command to verify authorized permissions based on at least one of the multiplicity of authorization policy modules.

8. The method of claim 7, comprising:
calling the general-purpose library;
using the at least one of the multiplicity of interfaces to determine source of the authorization attestation information;
selectively executing the program or the command based on the corresponding associations between the roles and permissions.

9. The method of claim 7, comprising:
loading the program or the command to execute as an application program;
determining a role of the application program;
associating the role with the program or the command; and
if an action is attempted, determining whether or not the role is associated with the program or the command.

10. The method of claim 9, comprising:
using the general-purpose library and the multiplicity of interfaces to retrieve and examine the permissions associated with the role of the program or the command; and
selectively allowing the action depending upon the permissions to do so.

11. An article comprising a medium storing instructions that, when executed by a processor-based system result in:
selectively authorizing at least one of installation and execution for different executable elements at a user platform based on a general-purpose library that provides a multiplicity of interfaces in order to securely control the execution environment in a device.

12. The article of claim 11 comprising a medium storing instructions, that, when executed by a processor-based system result in:
using the multiplicity of interfaces of the general purpose library to define a multiplicity of authorization policy modules for said different executable elements.

13. The article of claim 12 comprising a medium storing instructions, that, when executed by a processor-based system result in:
enabling one or more authorization models at the user platform based on at least one of the multiplicity of authorization policy modules.

14. The article of claim 12 comprising a medium storing instructions, that, when executed by a processor-based system result in:
implementing an application programming interface in the device based on at least one of the multiplicity of authorization policy modules; and
accessing the general-purpose library using the application programming interface to implement, configure, or enforce said one or more authorization models.

15. The article of claim 12 comprising a medium storing instructions, that, when executed by a processor-based system result in:
defining one or more authorizing parties for the device;
defining permissions for the authorizing parties; and
selectively grouping the permissions for the authorizing parties to configure a multiplicity of sets and permissions.

16. The article of claim 15 comprising a medium storing instructions, that, when executed by a processor-based system result in:
associating the sets of permissions with the roles of the authorizing parties;
configuring the roles to express different kinds of authorizing parties based on the associations between the roles and permissions;
specifying authorization for execution of said different executable elements with the permissions associated with roles.

17. The article of claim 16 comprising a medium storing instructions, that, when executed by a processor-based system result in:
receiving authorization information on the user platform;
receiving said different executable elements from said one or more authorizing parties, wherein said different executable elements including a program or a command; and
receiving authorization attestation information with the program or the command to verify authorized permissions based on at least one of the multiplicity of authorization policy modules.

18. The article of claim 17 comprising a medium storing instructions that, when executed by a processor-based system result in:
calling the general-purpose library;
using the at least one of the multiplicity of interfaces to determine source of the authorization attestation information;
selectively executing the program or the command based on the corresponding associations between the roles and permissions.

19. The article of claim 17 comprising a medium storing instructions that, when executed by a processor-based system result in:
loading the program or the command to execute as an application program;
determining a role of the application program;
associating the role with the program or the command; and
if an action is attempted, determining whether or not the role is associated with the program or the command.

20. The article of claim 19 comprising a medium storing instructions that, when executed by a processor-based system result in:
using the general-purpose library and the multiplicity of interfaces to retrieve and examine the permissions associated with the role of the program or the command; and
selectively allowing the action depending upon the permissions to do so.

21. A platform comprising:
a processor;
an antenna coupled to the processor to enable wireless communications over a network; and
a storage device coupled to the processor, to store instructions that selectively authorize at least one of installation and execution for different executable elements at the platform based on a general-purpose library that provides a multiplicity of interfaces in order to securely control the execution environment in a device.

22. The platform of claim 21, further comprising an application programming interface to use the multiplicity of interfaces of the general-purpose library to define a multiplicity of authorization policy modules for said different executable elements.

23. The platform of claim 22, wherein said application programming interface enables one or more authorization models for the platform based on the multiplicity of authorization policy modules.

24. The platform of claim 23, wherein said application programming interface accesses the general-purpose library to at least one of implement, configure, and enforce said one or more authorization models.

25. A software architecture for a distributed computing system comprising:
a user platform having a multiplicity of agents configured to receive different executable elements submitted by another platform over a wireless communication network; and
an application programming interface disposed on the user platform to present policies used by the agents to selectively authorize at least one of installation and execution for different executable elements at the user platform based on a general-purpose library that provides a multiplicity of interfaces in order to securely control the execution environment in a device.

26. The software architecture of claim 25, wherein said device is a cell phone.

27. The software architecture of claim 25, wherein the agents enable:
defining one or more authorizing parties for the device;
defining permissions for the authorizing parties;
selectively grouping the permissions for the authorizing parties to configure a multiplicity of sets and permissions;
associating the sets of permissions with the roles of the authorizing parties;
configuring the roles to express different kinds of authorizing parties based on the associations between the roles and permissions; and
specifying authorization for execution of said different executable elements with the permissions associated with roles.

28. An application programming interface embodied on one or more computer readable media, comprising:
a first interface to define at least two sets of executable elements;
a second interface to provide a set of authorization rights associated with at least two authorizing parties; and
a third interface to selectively assign different authorization rights than the set of authorization rights to a different number of authorizing parties across said at least two authorizing parties for said at least two sets of executable elements.

29. The application programming interface of claim 28 further comprising:
a fourth interface to enable execution of a selectable set of executable elements of said at least two sets of executable elements based on the assigned authorization rights to the different number of authorizing parties.

30. The application programming interface of claim 29, wherein said fourth interface verifies the assigned authorization rights to the different number of authorizing parties for the selectable set of executable elements.
